(19) United States
(12) Patent Application Publication
(10) Pub. No.: US 2003/0173713 A1
(43) Pub. Date: Sep. 18, 2003

(54) Maskless stereo lithography method and apparatus for freeform fabrication of 3-D objects

(76) Inventor: Wen-Chiang Huang, Auburn, AL (US)

Correspondence Address: Wen- Chiang Huang, 2076, S. Evergreen Dr., Auburn, AL, 36830, US

(21) Appl. No.: 10/007,570

(22) Filed: Dec. 10, 2001

(51) Int. Cl. B29C 35/08; B29C 41/02

(52) U.S. Cl. 264/401; 264/497; 425/174.4

(57) ABSTRACT

A maskless stereo lithography method and apparatus for forming a three-dimensional object from a plurality of adhered laminae by exposing successive layers of a photo-curable material to a micro-focused energy beam generated by an array of Fresnel zone plates. The method includes the steps of (A) providing a controllable array of Fresnel zone plates; (B) forming a layer of material adjacent to any last formed layer of material in preparation for forming a subsequent lamina of the object; (C) exposing the material to the micro-focused energy beam to form the subsequent lamina of the object; and (D) repeating the steps of forming and exposing a plurality of times in order to form the object from a plurality of adhered laminae, wherein the array of Fresnel zone plates are employed to focus parallel beamlets of energy beam from a source so that the beamlets converge to an array of focal points at predetermined positions of a lamina in accordance with a computer-aided design file of the object.

### BACKGROUND OF THE INVENTION

1. Field of the Invention

This invention pertains to a maskless stereo lithography method and apparatus for fabricating an integral three-dimensional (3-D) object from a photo-curable material composition in accordance with a computer-aided design (CAD) of this object. In particular, this invention provides a layer-additive method and apparatus for fabricating a 3-D object that (1) contains ultra fine-scaled features and/or (2) is made of a photo-curable material composition containing a high loading of ceramic and/or metallic particles. An array of Fresnel zone plates are used to micro-focus an energy beam to form a curing image pattern that cures the photo-curable material composition layer by layer.

2. Description of Related Art

Rapid prototyping (RP), layer manufacturing (LM) or solid freeform fabrication (SFF) has become an increasingly important manufacturing tool. Specifically, in the mid-1980's, an automated process for preparing three dimensional articles termed “stereolithography”, was developed as indicated by e.g., U.S. Pat. No. 4,575,330, issued to C. W. Hull on Mar. 11, 1986. In the stereolithography process, hereinafter “SLy”, a substrate is immersed in a photo-curable resin to a predetermined, shallow depth, and scanned with a highly focused or collimated ultraviolet laser beam. The laser scan is computer controlled, with the scanning parameters derived from a CAD file corresponding to a cross-section of the 3-D object shape. The photo-curable resin polymerizes to a solid material where struck by the laser beam, forming a single layer having a thickness in the range of 100-200 μm. The substrate is then lowered in the resin bath forming an additional polymerizable layer, which is in turn scanned by the laser with a pattern corresponding to the shape of the new layer as defined by the CAD. Prior to the second or subsequent laser scan, a wiping blade is often passed along the uppermost surface to ensure a uniform resin layer depth. By repeating this process by a predetermined number of times, a plastic article having the dimensions and shape of the 3-D object is produced.

U.S. Pat. No. 4,752,498, issued to E. V. Fudim on Jun. 21, 1988, describes an improved method of forming three-dimensional objects, which comprises irradiating an uncured photopolymer by transmitting an effective amount of photopolymer solidifying radiation through a radiation transmitting material which is in contact with the uncured liquid photopolymer. The transmitting material is a material which leaves the irradiated surface capable of further cross-linking so that when subsequent layer is formed it will adhere thereto. Using this method, multilayer objects can be made. In U.S. Pat. No. 4,801,477, issued also to Fudim on Jan. 31, 1989, mention is made of a light guide, which may be made of material containing copper, oxygen, or other ingredients that may inhibit photopolymer cross linking. Table 1 of U.S. Pat. No. 6,241,934 (Jun. 5, 2001 to Everett, et al.) provides an extensive list of the patents that are related to SLy. These patents are believed to represent the state of the art of SLy.

In solid ground curing (SGC, a variant of SLy), each layer of a 3-D object is generated by a multi-step process. A thin layer of liquid polymer is prepared and then exposed to UV through a patterned mask having transparent areas corresponding to the cross section. UV radiation passing through the mask cures the exposed areas of the polymer. The remaining uncured polymer, while still a liquid, is then removed and replaced by wax. In the final step, both polymer and wax are machined to a uniform thickness, forming a smooth surface on which the next layer is built. Upon completion of the multi-layer process, the desired 3-D object is imbedded within a solid block of wax, which is then melted and removed. This is a very tedious process, demanding the operation of many pieces of heavy or expensive equipment. The SGC method is described in U.S. Pat. No. 5,031,120 (Jul. 9, 1991 to Pomerantz, et al.) and U.S. Pat. No. 5,287,435 (Feb. 15, 1994 to Cohen, et al.).

There are several shortcomings associated with the conventional SLy and SGC processes:

(1) The processes are essentially limited to the fabrication of a photo-curable resin containing no or small percentage of fillers such as ceramic and metallic particles. In many applications, it is desirable to be able to utilize SLy for the rapid prototyping or production of sinterable ceramic or metal parts that have a high filler loading (proportion). Heretofore, this has been difficult, if not impossible. The resins useful in the traditional SLy must have a relatively low viscosity, generally below 3,000 mPa-s, to allow for recoating of the part for successive laser scanning. For successful use of ceramics in SLy, the solid loading must be high, yet the resin must be stable with regard to sedimentation as well as presenting essentially Newtonian behavior, i.e., the resin must not be thixotropic, and must be able to flow even under low shear conditions. Such resins are not readily available on a commercial basis.

Photo-curable resins containing ceramic pigments have been used as ultraviolet curable coatings, for example, titanium dioxide pigmented UV-curable paints. However, the particle loading is far too low to produce a useable ceramic material. Modestly loaded, photo-curable pastes containing metal particles or ceramic particles have been utilized to prepare microelectronic devices such as thin film capacitors. However, even with particle loadings in the range of 20-43 volume percent, the resins are highly viscous pastes requiring doctor blade coating. Such pastes are not suitable for SLy, nor is their particulate loading, even at their paste-like viscosity, sufficient to prepare useful sinterable metal or ceramic parts which can be fired without exhibiting shrinkage and while maintaining acceptable physical properties. It would be desirable to develop a modified process that either obviates the need for re-coating or readily feeds successive layers for laser scanning or scanning by other high energy radiations.

(2) The visible light, ultraviolet (UV) light or UV laser beam commonly used in a SLy or SGC system has a limited penetrating distance (thickness) when the photo-curable resin is loaded with a high proportion of ceramic or metallic particles. This tends to result in inhomogeneous resin cure characteristics and hence poor product quality since the upper portion of a layer would be exposed to a high dosage of UV energy while the bottom portion would receive very little or no UV exposure.

(3) The traditional UV light or UV laser source provides a beam with an excessively large spot size that it does not lend itself for the production of a part with ultra-fine features (e.g., features as small as 1 μm or smaller).

In the field of microelectronic manufacturing, the conventional 2-D lithography is performed by a variety of systems and methods. For instance, optical projection lithography employs a reticle (mask) which is then imaged onto a substrate. The reticle or mask contains the pattern to be created on the substrate, or a representation thereof. In some cases, the optics produces a reduction of the mask image by a factor between 4 and 10. In other cases, there is no reduction of magnification, referred to as 1-to-1 imaging. Another method, conventional X-ray lithography, employs a mask held in close proximity (e.g., a gap of zero to 50 micrometers) to the substrate. By passing x-ray radiation through the mask, the pattern on the mask is replicated in a radiation-sensitive film or resist on the substrate. Both optical projection lithography and conventional X-ray lithography require the creation of a mask for each image pattern, which renders both methods tedious and expensive.

Electron-beam lithography is normally performed by scanning a well focused electron beam over a resist-coated substrate. By turning the beam on and off at appropriate times, in response to instructions from a control computer, any general 2-dimensional pattern can be created. This form of lithography is referred to as “maskless lithography”, since no mask is employed. Maskless lithography methods have a significant advantage over those that require a mask.

Another maskless lithography method involves utilizing an array of light beams which scan across a substrate and are shut on and off in response to commands from a control computer. This optical pattern generator system has a resolution being limited by the numerical aperture of the lenses used and the wavelength of the ultraviolet radiation, based on a well-known relationship: p=λ/NA, where p is the minimum resolvable period, λ is the wavelength of the radiation, and NA is the numerical aperture of the lens.

X-ray lithography is known to be capable of manufacturing semiconductor products with minimum size features of 100 nm and below, due to its capabilities for high resolution. For instance, line-widths as narrow as 18 nm have been replicated with x-ray lithography and back-scattering from the substrate is practically non-existing. However, conventional x-ray lithography has exhibited several significant drawbacks: the technical difficulty and high cost of making the x-ray mask, distortion in the pattern on the mask due to the stresses in the x-ray absorbing material that forms the pattern, and the lack of stiffness in the membrane that supports the absorber pattern.

Another potential problem with conventional x-ray lithography, which arises especially when features of 100 nm or smaller are to be produced, is that the mask-substrate gap, G, must be decreased according to the approximate relationship: G=αW²/λ, where W is the minimum feature size, λ is the x-ray wavelength, and α is in the range 1 to 1.5. Based on this relationship, for feature sizes below 50 nm, the gap must be below 4 μm. Such small gaps or even mask-substrate contact, are not desirable nor acceptable in a real manufacturing environment. Clearly, it would be desirable to develop a form of x-ray lithography that avoids the necessity of making a mask and the necessity of utilizing a small gap. This has been accomplished by H. I. Smith (U.S. Pat. No. 5,900,637, May 4, 1999) for maskless 2-D lithographic fabrication of micro-electronic devices using a multiplexed array of Fresnel zone plates. Fresnel zone plates are capable of focusing an energy beam (including UV, X-ray, particle beam, etc.) into an array of points smaller than 20 nm in diameter. The present invention provides a Fresnel zone plate-based maskless stereo lithography for the freeform fabrication of a 3-D object of a complex shape with ultra-fine features. Furthermore, due to the higher penetrating power of X-ray in comparison with the UV laser beam, the present X-ray based maskless stereo lithography provides a capability for the freeform fabrication of a 3-D object with a high metallic/ceramic content.

Although in Hull's patent (U.S. Pat. No. 4,575,330) and other patents related to SLy, it was often stated that “synergistic stimulation” that could be used to cure a photo-curable resin could include particle bombardment (e.g., electron beams), chemical reactions by spraying materials through a mask, or impinging radiation other than ultraviolet light (e.g., X-ray), these patents have not fairly suggested how X-ray could be applied for effectively accomplishing stereolithography. This is indeed not a trivial task. This is one of the reasons why commercial SLy systems thus far have been limited to the use of a UV light or UV laser beam. Without the Fresnel zone plate technique, it has not been possible to effectively focus an X-ray beam to a small focal point and to exercise a reliable control over the switch-on and switch-off steps of an focused X-ray beam. It was never recognized in these earlier patents that an X-ray beam or other types of energy beam could be focused to the extent that features as small as 18 nm could be produced. Traditional SLy systems have a resolution that is normally 100 μm in size or larger.

### SUMMARY OF THE INVENTION

Accordingly, it is an object of this invention to provide a method and apparatus for performing maskless stereolithography that preserves the attractive high-resolution and high penetrating power capabilities of maskless energy beam lithography, particularly x-ray lithography.

The presently invented maskless stereolithography is performed to build a 3-D object from a computer-aided design (CAD) file of the object without the need for a mask (per layer) that contains the pattern to be exposed. More specifically, the method employs an array of Fresnel zone plates to focus parallel beamlets of electromagnetic radiation (X-ray, in particular) so that they converge to an array of focal points on a layer of photo-curable resin composition containing from approximately 0 to 80% of ceramic and/or metallic powder particles. The beamlets can be individually turned on or off by means of shutters that obstruct a beamlet, or by deflecting small mirrors that would otherwise direct a beamlet to its Fresnel zone plate. Pattern generation is accomplished by moving the layer on a work surface while multiplexing the individual beamlets on or off by means of electrical or optical signals. One array (or several arrays) of focal points, in combination, constitute the CAD-defined cross-sectional profile (shape and dimensions) of a layer of photo-curable resin composition (a lamina). The portions of a layer of photo-curable resin composition that are exposed to these focused X-ray points are “cured” or converted to a substantially solidified solid, forming a lamina. Once a lamina is formed, another fresh layer of resin composition is prepared (dispensed or fed to the work surface) and the same steps are repeated to build another lamina, which is adhered to the first layer. The same steps are then repeated to build subsequent layers, which are adhered to one another to form a multi-layer 3-D shape.

According to an embodiment of the present invention, in a maskless stereolithography apparatus, an array of Fresnel zone plates are illuminated by parallel beamlets of narrow-band electromagnetic radiation. The individual zone plates focus a significant fraction of the incident radiation to foci on a layer located at least several micrometers distant. The beamlets are capable of being individually turned on or off by shutters, or by deflecting small mirrors that would otherwise direct a beamlet to its Fresnel zone plate. Pattern generation is accomplished by moving the work surface, on which the object is being built, while multiplexing the individual beamlets on or off in accordance with the CAD data file.

### BRIEF DESCRIPTION OF THE DRAWINGS

FIG. 1 Schematic of a Fresnel zone plate based maskless stereolithography apparatus.

FIG. 2 Schematic of a possible Fresnel zone plate sub-system that is capable of providing an array of micro- or nano-focused X-ray beam spots for maskless stereolithography.

FIG. 3 Schematic of another maskless stereolithography apparatus that involves separate steps of feeding a powder layer and feeding adhesive resin. This apparatus makes it possible to feed a photo-curable resin composition with a high powder particle content (e.g., from 50% up to 80%).

### DETAILED DESCRIPTION OF THE PREFERRED EMBODIMENT

The present invention provides a new and improved method and apparatus for fabricating a three-dimensional (3-D) object by forming successive, adjacent, cross-sectional laminae of that object. A maskless energy beam lithography technique (particularly, maskless X-ray lithography) is used to alter the physical state of a material composition in successive laminae, which are automatically integrated as they are formed to define the desired 3-D object.

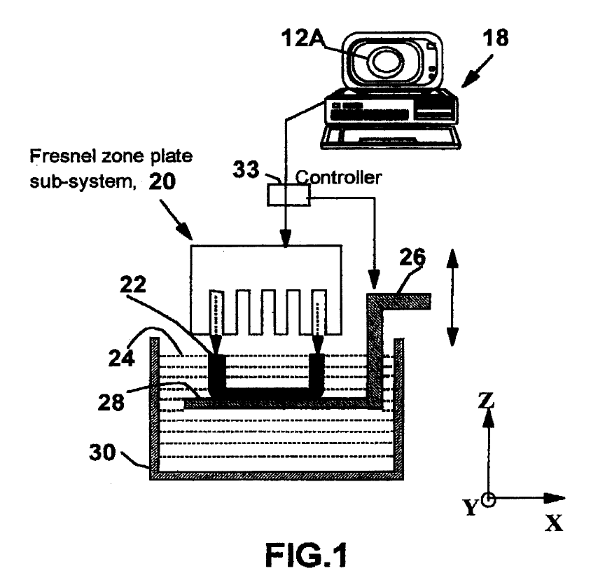

In a preferred embodiment, by way of example and not necessarily by way of limitation, the present invention harnesses the principles of computer generated graphics in combination with maskless stereolithography, i.e., the application of maskless lithographic techniques to the production of 3-D objects, to simultaneously execute computer aided design (CAD) and computer aided manufacturing (CAM) in producing 3-D objects directly from the instructions of a computer 18 (FIG. 1). Preferably, the CAD geometry of a 3-D object is sliced into a predetermined number of thin layers or laminae, each of a desired shape (cross-sectional profile, e.g. 12A in FIG. 1) and thickness. These shape and dimensional data are then converted to position coordinate or vector signals that are used to drive the object building process.

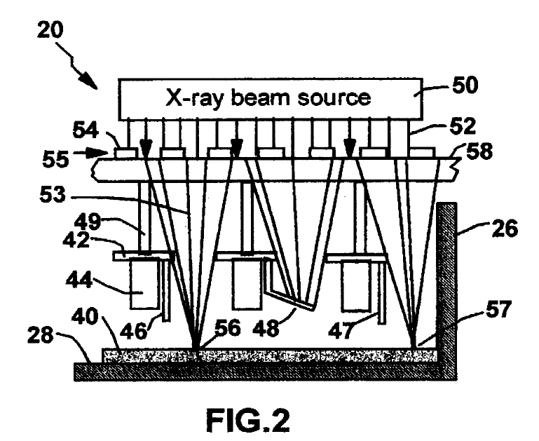

As a preferred embodiment, referring to FIG. 1 and FIG. 2, a vat 30 is used to contain a photo-curable resin composition. A support platform 26, which is moveable at least along the Z-direction (vertical) of an X-Y-Z Cartesian coordinate system, provides a work surface 28 upon which the object is built. The maskless stereo lithography method begins with the feeding of a first layer 40 of a photo-curable resin composition onto the work surface 28 (FIG. 2). By utilizing a Fresnel zone plate sub-system 20, a micro-focusable beam of X-radiation (or any other type of high energy radiation such as Gamma ray, atomic particles, UV, and laser) is programmed to form an array of focal points (e.g., 56 and 57) on predetermined positions of the first layer, which correspond to the first cross-section of the object. The term “micro-focusable” means the ability of this technique to produce a feature as small as 1 μm or smaller, possibly down to nanometer-scaled. The resin composition in these positions, originally in a flowable state, are converted into a substantially non-flowable or solid state to form a first lamina of the object. The object is then moved, in a programmed manner, in the Z-direction by the thickness of one layer. A second layer of photo-curable resin composition is then coated onto the first layer and the Fresnel zone plate sub-system is used to cure the resin composition at the desired spots, again in accordance with the CAD-derived position or vector coordinate signals to form the second cross-section or lamina, which is adhered to the first layer. The same steps are then repeated to build a subsequent layer on top of the immediately preceding layer. This process is continued until the entire object is formed. Essentially all types of object forms can be created with the technique of the present invention. Complex forms are more easily created by using the functions of a computer to help generate the programmed commands and to then send the program signals to the Fresnel zone plate subsystem, resin composition feeding or coating device, 3-D motion devices (e.g., gantry table, positioning stage, linear motion devices, motors, and drivers, etc.), and a motion controller.

In each layer being built, the portion (e.g., including 22) of the resin composition being exposed to the curing radiation is referred to as the “positive region” and the remaining portion (e.g., 24, un-exposed to the radiation and being maintained in a flowable or liquid state) is referred to as the “negative region”.

In the practice of the present invention, a body of a photo-curable resin capable of solidification in response to prescribed X-ray beam is first appropriately contained in any suitable vessel or vat to define a designated work surface on which successive cross-sectional laminae can be built. A micro-focused X-ray beam is applied as a graphic pattern at the first layer on the work surface to form a thin, solid layer. Second and subsequent layers are then built, one adhered to another, with each layer representing an adjacent cross-section of the three-dimensional object to be produced. Superposition of successive adjacent layers on each other is automatically accomplished, as they are formed, to integrate the layers and define the desired 3-D object. As the resin cures and solid material forms as a thin lamina on the work surface of a suitable platform, the platform is moved away (vertically downward) in a programmed manner by any appropriate actuator, typically all under the control of a micro-computer or the like. In this way, the solid material that was initially formed at a target surface plane is moved away from that surface plane and new liquid resin flows into the target surface position (this is a “re-coating” process). A portion of this new liquid resin is, in turn, converted to solid material by the programmed X-radiation spots to define a new lamina, and this new lamina adhesively connects to the material adjacent to it, i.e., the immediately preceding lamina. This process continues until the entire 3-D object has been formed. The formed object is then removed from the container and the apparatus is ready to produce another object, either identical to the first object or an entirely new object generated by a computer or the like.

An example of a preferred Fresnel zone plate sub-system arrangement is shown in FIG. 2. This cross-sectional schematic diagram illustrates the focusing of incident beamlets 52 from an x-ray beam source 50 onto the first layer 40 as focused beamlets 53. The arrangement includes micro-mechanical shutter or mirror devices 44 with actuated shutters 48, which turn the focused beamlets on and off in response to commands from a control computer. The shutter devices 44 are interposed between the zone-plate array 54, joists 49, stops 42, and the work surface 28. In FIG. 2, the first and third beamlets from the left are indicated as being in the ON state and the second beamlet is indicated as being in the OFF state. The operation of this Fresnel zone plate sub-system, including the beam modulators (micro-mechanical shutters or mirrors) is controlled by a control device, which is preferably under the command of a control computer.

As shown in FIG. 2, each of the zone plates 54 of the array 55 is capable of focusing a collimated beamlet 52 of x-rays to a fine focal spot (e.g., 56 or 57) on the first layer 40, which is supported on a working surface 28. To produce a lamina of a desired profile or pattern, the first layer is scanned under the array, while the individual beamlets 53 are turned on and off as needed by means of the micro-mechanical shutters 44, one associated with each zone plate. A detailed discussion on Fresnel zone plates may be found in U.S. Pat. No. 5,900,637. The principle of operation of Fresnel zone plates is well known to those of skill in the art. The addressing of the individual shutters can be done either by electrical wiring to each or by means of optically addressed photo-diodes, one associated with each shutter or mirror. The specific mode of such multiplexed addressing, and the associated software to coordinate the scanning and the multiplexing, is considered as being understood by those who are skilled in the art.

The geometric configuration of a Fresnel zone plate sub-system can be adjusted to achieve the highest possible resolution, yet still meeting other requirements (e.g., penetrating depth of a focused beam). For sub-100 nm stereo lithography, an appropriate electromagnetic wavelength to use is either 4.5 nm, at the carbon K absorption edge, or around 1 nm. The intrinsic resolution at the 4.5 nm wavelength is about 5 nm, which is probably at or just beyond the practical limit of the stereo lithographic process itself. For zone-plate-array maskless stereolithography, 4.5 nm is the optimal wavelength from the points-of-view of resolution, source characteristics, zone plate fabrication, and absence of spurious effects. At a wavelength of 1 nm, somewhat poorer resolution would be achieved due to the larger range of photo-electrons generated by the 1 nm x-rays in the resin and from the work surface. Furthermore, the zone plates appropriate for 1 nm wavelength are more difficult to fabricate, and the x-ray sources are less efficient.

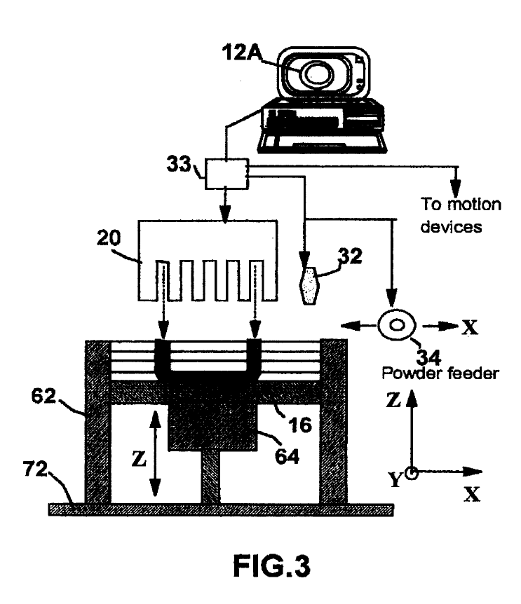

The photo-curable resin composition used in FIG. 1 or FIG. 2 can be a resin containing from 0% to approximately 50% of ceramic and/or metallic particles. A higher particle content would make it difficult to coat or re-coat a fresh layer of resin composition onto a preceding layer. This difficulty, which is one of the intrinsic problems of traditional stereolithography, may be overcome by using a different way to feed individual layers of photo-curable resin compositions. Hence, FIG. 3 illustrates another preferred embodiment of the presently invented apparatus for making a three-dimensional object. This apparatus is equipped with a computer for creating a drawing or geometry 12A of an object (shown as a cross-section of a coffee cup) and, through a hardware controller 33 (including signal generator, amplifier, and other needed functional parts) for controlling the operation of other components of the apparatus.

These other components include a material-dispensing means (comprising a photo-curable resin sprayer 32 and a powder feeder 34), and an object-supporting platform or work surface 16. The supporting platform 16 is preferably capable of moving vertically in the Z-direction through a linear motion device 64. The supporting platform and the object being built are accommodated in a chamber 62, which is supported by a member 72. The hardware controller 33 may comprise a Fresnel zone plate array controller, material-dispensing controller, and a motion controller. The powder feeder 34 is used to feed layers of fine powder particles onto the surface of a supporting platform 16 or a preceding layer, one thin layer at a time, much like the powder feeding step commonly used in selected laser sintering (e.g., U.S. Pat. No. 4,863,538, Sept. 5, 1989 to C. Deckard) or 3-D powder printing (e.g., U.S. Pat. No. 5,204,055, Apr. 20, 1993 to Sachs, et al.). The resin sprayer 32 is used to spray a thin layer of photo-curable resin onto a powder layer, allowing the resin to permeate through the gaps between fine solid particles. The resin, if cured by X-radiation at selected spots (in the positive region), acts as an adhesive to bond together the otherwise loosely packed powder particles to form an integral layer or lamina. The un-cured adhesive resin, in the negative region, will remain soluble in a solvent and may be easily removed upon completion of a build process.

Optional temperature-regulating means (e.g., heaters and temperature controllers, not shown) and pump means (not shown) may be used to provide a protective atmosphere and a constant temperature over a zone surrounding the work surface where a 3-d object is being built. The heaters may be used to heat the resin prior to, during, or after being exposed to the X-radiation. A motion device (not shown) is used to position the work surface 16 with respect to the material-dispensing devices (32 and 34) and the Fresnel zone plate sub-system 20. After a layer of powder-adhesive mixture is deposited and a cross-section of the 3-D object is built, the material-dispensing means (32 and 34) and the work surface 16 are to be shifted away from each other by a predetermined distance to get ready for dispensing a next layer of photo-curable material mixture (by feeding a layer of powder, followed by dispensing a thin layer of photo-curable adhesive resin).

In one preferred embodiment of the present invention, the Fresnel zone plate sub-system is capable of moving vertically along the Z-direction as defined by the rectangular coordinate system. When this sub-system 20 is operated in accordance with the CAD-derived coordinate data, it provides a pre-determined pattern of X-ray beams to at least partially cure the adhesive that bonds powder particles within predetermined areas (the positive region) of a layer corresponding to a cross-section of the 3-D object being built. The adhesive in other areas (the negative region) of the same layer will not be exposed to the radiation. Therefore, the powder particles in the negative region will not be “bonded” by the adhesive; they are simply wetted by or mixed with uncured, soluble liquid adhesive that can be later removed by simply dissolving the adhesive in a proper solvent. Once a layer is built (with the powder particles in the desired cross-section being bonded), the Fresnel zone plate sub-system is switched off and preferably also raised to a higher, stand-by position as indicated in FIG. 3.

The resin composition (a mixture of powder and adhesive resin) in each layer can be heated by other heat sources disposed near the object-building zone to a temperature (Tpre) that is not sufficient to significantly initiate a cure reaction, but is sufficient to accelerate the cure reaction once initiated by the X-ray. Chemical reaction rates are known to increase normally with increasing temperature, but temperature alone may not be sufficient to start out a chemical reaction. The heating operation would significantly reduce the X-ray intensity requirement or exposure time. Adhesive curing of a layer does not necessarily have to be complete before attempting to build a subsequent layer. The cure reaction in a layer may be allowed to continue while other layers are being built, provided the curing is proceeded to an extent that the layer is sufficiently rigid and strong to support its own weight and the weight of subsequent layers.

The physical sizes of the Fresnel zone plate sub-system are preferably sufficient to cover the complete envelop of a powder-adhesive mixture layer so that there will be an one-to-one image mapping from the zone plate array to the adhesive-curing pattern and a complete cross-section of the 3-D object can be built in seconds. However, if the physical sizes of this subsystem are smaller than those of a mixture layer, the source may be permitted to travel on an X-Y plane. A few translational movements will let the array completely cover the entire layer and allow a complete cross-section to be built in a few exposures.

A wide array of material-dispensing devices may be used in the present freeform fabrication method and apparatus for feeding and spreading up thin layers of a material mixture, one layer at a time. We have found it satisfactory to use a device (not shown) to provide a mound of powder particles with a predetermined volume at a time onto one end of the work surface and move a rotatable drum (34 in FIG. 3) from this end to another end with a desired spacing between the drum and the work surface. During such a translational motion, the drum also rotates in a direction counter to the translation direction, leaving a mixture layer thickness being approximately equal to the desired spacing. A paint sprayer may be used as the adhesive resin sprayer in the practice of the subject patent.

The photo-curable resin may consist of such adhesive compositions as a base resin, a hardening or cross-linking agent, a photo-initiator, a photo-sensitizer, and possibly a reaction accelerator. The photo-curable adhesives that can be used in the practice of the present invention are any compositions which undergo solidification under exposure to an actinic radiation. The word “photo” is used here to denote not only light, but also any other type of actinic radiation (e.g., X-ray) which may “transform” a liquid adhesive to a solid by exposure to such radiation. A wide variety of photo-curable adhesive resin compositions are available in the art. Examples of this transformation behavior include cationic polymerization, anionic polymerization, step-growth polymerization, free radical polymerization, and combinations thereof. Cationic polymerization is preferable and free radical polymerization is further preferable. One or more monomers may be utilized in the compositions. Monomers may be mono-functional, di-functional, tri-functional or multi-functional acrylates, methacrylates, vinyl, allyl, and the like. The adhesive compositions may comprise other functional and/or photo-sensitive groups such as epoxy, vinyl, isocyanate, urethane, and the like.

A large number of examples of photo-curable adhesive compositions can be found in both open literature and patents. For instance, the following U.S. patents provide a good source of these adhesive compositions: U.S. Pat. No. 6,110,987 (Aug. 29, 2000 to Kamata, et al.) and U.S. Pat. No. 5,721,289 (Feb. 24, 1998 to Karim, et al.). Commercially available photo-curable polymers that can be successfully used in the present method include DSM Somos® solid imaging/rapid prototyping materials (e.g., Somos® 2100, 3100, 6100, 7100, 7110, 7120, 8100, 8110, and 8120 series) supplied by DSM (New Castle, Del., U.S.A.), Dymax Multi-cure®, Light Weld® and Ultra Light Weld® series fast-curing adhesives supplied by Dymax Corp. (Torrington, Conn. , U.S.A.), Solimer® resins from Cubital America (Troy, Mich., U.S.A.), and SLa resins (CibaTool® SR 5170, 5180, and 5190) supplied by Ciba Geigy Specialty Chemicals Corp. (Los Angeles, Calif., U.S.A.).

Th powder particles may comprise fine particles that make up the bulk of an object and additives such as physical or chemical property modifiers. These ingredients may contain a reinforcement composition selected from the group consisting of short fiber, whisker, and particulate reinforcements such as a spherical particle, ellipsoidal particle, flake, small platelet, small disc, etc. These ingredients may also contain, but not limited to, colorants, anti-oxidants, anti-corrosion agent, sintering agent, plasticizers, etc. In this method, the primary body-building powder may be composed of one or more than one type of fine particles. These fine powder particles could be of any geometric shape, but preferably spherical. The particle sizes are preferably smaller than 10 μm, further preferably smaller than 1 μm, and most preferably smaller than 10 nm. The size distribution is preferably uniform. The powder materials can be selected from polymers, ceramics, glass, metals and alloys, carbon, and combinations thereof. Most of solid materials can be made into fine particles by using, for instance, a high-energy planetary ball-milling method. The fact that any material that is available in a powder form can be used in the presently invented method makes this a highly versatile method.

Referring again to FIG. 3, the work surface 16 is located in close, working proximity to the dispensing devices. The work surface 16 and the material-dispensing devices (32,34) are equipped with mechanical drive means for moving the material-dispensing device from one end of the work surface to another end and for displacing the work surface a predetermined incremental distance relative to the material-dispensing device along the Z-direction. The work surface and the Fresnel zone plate sub-system can also be moved relative to each other vertically along the Z-direction and preferably also moveable along the X- and Y-directions so that even a smaller-sized Fresnel zone plate sub-system can cover a full powder-adhesive mixture layer in just a few displacement movements. This can be accomplished, for instance, by allowing the material-dispensing devices to be driven by at least one linear motion device to translate along the X-direction, which is powered by a corresponding stepper motor, and concurrently driven to rotate in a direction counter to the translational motion to deposit a layer of material mixture. Preferably the Fresnel zone plate sub-system is driven by a stepper motor to move up and down in the Z-direction relative to the work surface. Motor means are preferably high resolution reversible stepper motors, although other types of drive motors may be used, including linear motors, servo motors, synchronous motors, D.C. motors, and fluid motors. Mechanical drive means including linear motion devices, motors, and gantry type positioning stages are well known in the art. The drive means, motion devices, and planar heat source are preferably subject to automated control by a computer through a hardware control system (33 of FIG. 3) These movements will make it possible for the material-dispensing means to feed successive layers of a powder-adhesive mixture and for the Fresnel zone plate sub-system to move up (to a stand-by position) and down (at a distance to the current layer of resin composition), thereby forming multiple layers of materials of predetermined cross-sections and thicknesses, which build up on one another sequentially.

What is claimed:

1. A maskless stereolithography method of forming a three-dimensional object from a plurality of adhered laminae by exposing successive layers of a material to a micro-focused energy beam generated by an array of Fresnel zone plates, comprising:
(A) providing a controllable array of Fresnel zone plates;
(B) forming a layer of material adjacent to any last formed layer of material in preparation for forming a subsequent lamina of the object;
(C) exposing the material to the micro-focused energy beam to form the subsequent lamina of the object; and
(D) repeating the steps of forming and exposing a plurality of times in order to form the object from a plurality of adhered laminae,
wherein the array of Fresnel zone plates are employed to focus parallel beamlets of energy beam from a source so that said beamlets converge to an array of focal points at predetermined positions of a lamina in accordance with a computer-aided design file of said object.

2. The method of claim 1 further comprising a step of operating means for modulating individual ones of said array of focal points.

3. The method of claim 2, wherein said modulating means operates to selectively shut off and on said focal points.

4. The method of claim 1, wherein said step of forming a layer of material comprises coating or re-coating a thin layer of photo-curable resin.

5. The method of claim 1, wherein said step of forming a layer of material comprises coating or re-coating a thin layer of a material composition comprising a photo-curable resin and fine ceramic and/or metallic particles.

6. The method of claim 5, wherein said fine ceramic and/or metallic particles occupy at least 40% by volume of said composition.

7. The method of claim 1, wherein said step of forming a layer of material comprises feeding a layer of fine ceramic and/or metallic powder particles and, concurrently or sequentially, spraying a predetermined amount of a photo-curable resin onto said layer of powder particles.

8. The method of claim 1, wherein said energy beam is selected from the group consisting of ultraviolet, laser, X-ray, Gamma-ray, atomic particle beam, or a combination thereof.

9. An apparatus for forming a three-dimensional object from a plurality of adhered laminae by exposing successive layers of a photo-curable material composition to a micro-focused energy beam, comprising:
(a) a work surface to support the object while being built;
(b) material dispensing means disposed a distance from said work surface for feeding successive layers of a photo-curable material composition thereon, one layer at a time;
(c) a Fresnel zone plate sub-system disposed a distance above said successive layers of a photo-curable material composition for focusing an energy beam into an array of focal points to create a curing pattern on each of said successive layers for forming multiple laminae of said object;
(d) a Fresnel zone plate controller comprising modulating means and being electronically connected to said Fresnel zone plate sub-system;
(e) motion devices coupled to said work surface, said Fresnel zone plate sub-system, and/or said material-dispensing means for moving said material-dispensing means and said Fresnel zone plate sub-system relative to said work surface in a plane defined by first and second directions and in a third direction orthogonal to said plane to dispense and cure said successive layers of a photo-curable material composition, one layer at a time, for forming said 3-D object.

10. The apparatus of claim 9, further comprising a computer that controls the operation of said Fresnel zone plate sub-system.

11. The apparatus of claim 9, further comprising motion control means electronically connected to said motion devices to control the operation of said motion devices.

12. The apparatus of claim 9, wherein said energy beam comprises X-radiation.

13. The apparatus of claim 9, wherein said modulating means comprises micro-mechanical shutters.

14. The apparatus of claim 9, wherein said modulating means comprises micro-mechanical mirrors.

15. The apparatus of claim 9, wherein said material dispensing means comprises:
a vat to contain the photo-curable material composition;
a moveable support platform disposed a distance from said vat, said platform providing a work surface on which said object is supported while being built; and
coating means disposed a distance from said work surface for feeding said successive layers of a photo-curable material composition thereto, one layer at a time.

16. The apparatus of claim 9, wherein said material dispensing means comprises:
powder-dispensing means having an outlet directed to said work surface for feeding successive layers of powder particles onto said work surface one layer at a time; and
adhesive sprayer means having an outlet directed to said successive layers of powder particles for spraying a layer of a photo-curable resin onto each of said successive layers of powder particles for forming said successive layers of a photo-curable material composition.
